(19) United States
(12) Patent Application Publication
(10) Pub. No.: US 2025/0284694 A1
(43) Pub. Date: Sep. 11, 2025

(54) QUERYING SHARDED VECTOR DATABASES

(71) Applicant: Oracle International Corporation, Redwood Shores, CA (US)

(72) Inventors: Ghazi Nourdine Benadjaoud, Pleasanton, CA (US); Darshan Maniyani, Union CIty, CA (US); Aurosish Mishra, Foster City, CA (US); Shasank Kisan Chavan, Menlo Park, CA (US); Tirthankar Lahiri, Palo Alto, CA (US)

(21) Appl. No.: 19/076,138

(22) Filed: Mar. 11, 2025

Related U.S. Application Data
(60) Provisional application No. 63/563,926, filed on Mar. 11, 2024.

(51) Int. Cl. G06F 16/2455; G06F 16/334

(52) U.S. Cl. CPC G06F 16/2456; G06F 16/3347

(57) ABSTRACT

Techniques for querying sharded vector databases are provided. In one technique, a vector query that targets first and second sharded tables is received. In response, it is determined that the vector query includes a non-collocated join condition on the first and second sharded tables. In response, multiple shards storing the first and second sharded tables are identified, first data pertaining to the first sharded tables and second data pertaining to the second sharded table are retrieved from the shards, and a join operation is performed on the first data and the second data. A portion of results from the join operation is transmitted to each of the shards. Then, a top K result is received from each shard. A final top K result is generated based on the top K results from the shards. A response to the vector query is generated based on the final top K result.

### BENEFIT CLAIM

This application claims the benefit under 35 U.S.C. § 119 (e) of provisional application 63/563,926, filed Mar. 11, 2024, by Lahiri et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### TECHNICAL FIELD

The present disclosure relates generally to database sharding and, more particularly, to processing vector queries that target a sharded database.

### BACKGROUND

Some enterprises use a technology referred to as database sharding, in which segments (shards) of a data set are distributed across multiple databases on different computer systems. Sharding uses a shared-nothing architecture in which shards share no hardware or software. All of the shards together make up a single logical database, referred to a sharded database. Sharding is a database scaling technique based on horizontal partitioning of data across multiple independent physical database systems, each comprises one or more database servers and a database that is coupled to the one or more database servers. The one or more database servers may be multiple database servers that execute on different computing nodes, each of which are connected to a single database.

From the perspective of a database application, a sharded database appears to be a single database: the number of shards and the distribution of data across those shards may be (completely) transparent to database applications. From the perspective of a database administrator, a sharded database consists of multiple databases that may be managed collectively.

There may be multiple reasons for creating and managing a sharded database, such as volume, legal requirements, and availability. For example, the size of the data set that is to be partitioned into shards may be so large that a single database system is not able to store the data set. As another example, some countries require that user data pertaining to their citizens must physically be stored in those countries. Thus, a multi-national enterprise that stores the user data may set up or dedicate storage resources to be maintained in those countries in order to store the appropriate user data. As another example, some enterprises desire that their data (e.g., data from customers of an enterprise) be divided among multiple database systems (increasing availability) in case of an unanticipated shutdown of one of the database systems.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example vector database system for processing vector queries in a sharded database, in an embodiment;

FIG. 2 is a block diagram that depicts a query processing example for processing a single shard vector query;

FIG. 3 is a block diagram that depicts a query processing example for processing a vector query;

FIG. 4 is a block diagram that depicts a query processing example for processing a vector query that involves a non-collocated join;

FIG. 5 (consisting of FIGS. 5A and 5B) is a block diagram that depicts a query processing example for processing a cross-shard vector query that includes a non-collocated join and an added pre-filter operation, in an embodiment;

FIG. 6 is a flow diagram that depicts an example process for processing a cross-shard vector query that includes a non-collocated join, in an embodiment;

FIG. 7 is a block diagram that depicts a query processing example for processing a cross-shard vector query that includes a non-collocated join with post-filtering, in an embodiment;

FIG. 8 is a flow diagram that depicts an example process for processing a cross-shard vector query that includes a non-collocated join, in an embodiment;

FIG. 9 is a block diagram that illustrates a computer system upon which an embodiment of the invention may be implemented;

FIG. 10 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for processing vector queries in a sharded database are provided. In one technique, a vector query processor determines whether a vector query includes a join that is co-located. A co-located join is a type of join that combines data from tables that are co-located or on the same computing node or same database system. Conversely, a non-collocated join is a type of join that combines data from tables that are not co-located. Non-collocated joins are less efficient than co-located joins, which use less network usage and are faster. In this technique, if the vector query includes a join that is co-located, then the vector query is transmitted to each of multiple shards, or multiple database systems.

In a related technique, in response to determining that a vector query is non-collocated, one of two approaches may be implemented. In a pre-filter approach, data from both join tables are retrieved from multiple shards and joined at a coordinator node, resulting in a temporary table. Contents of that temporary table are then sent to each shard and joined, on each shard, with the portion of one of the sharded tables on that shard. The top-K result of that join is determined by each shard (e.g., by computing a vector distance between the query vector and each vector associated with each joined item) and transmitted to the coordinator node. The coordinator node combines the top-K results from the shards, sorts them (e.g., by vector distance), and selects the final top K.

In a post-filter approach, each shard uses a local vector index to identify a top-N result from scanning data from a first sharded table that is part of the non-collocated join. Each shard transmits its top-N result to a coordinator node. Each shard also transmits contents of a second sharded table (that is part of the non-collocated join) to the coordinator node. The coordinator node sorts the top-N results from the shards (e.g., by vector distance), selects the top M of that sorted result, and joins that top M with the data from the second sharded table. The result of the join is sorted and a top-K result is determined from that sort.

Embodiments improve computer-related technology related to sharded databases. Embodiments reduce the number of calculations that need to be performed to generate an accurate result for a vector query; thus, conserving processing power and lowering latency.

### System Overview

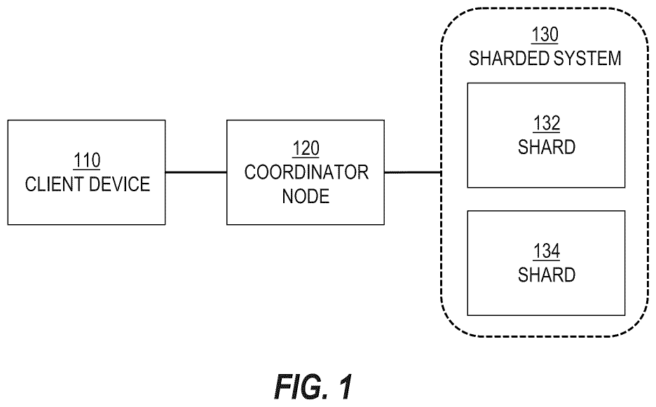

FIG. 1 is a block diagram that depicts an example system architecture 100 for processing vector queries in a sharded database, in an embodiment. System architecture 100 comprises a client device 110, a coordinator node 120, and a sharded system 130 that comprises multiple shards 132-134. Although only a single client device is depicted, system architecture 100 may be communicatively coupled with multiple client devices and, therefore, support multiple concurrent client requests. Similarly, although only two shards are depicted, coordinator node 120 may be communicatively coupled with many shards. Shards 132-134 collectively store a sharded database.

Coordinator node 120 is a computing device that is communicatively coupled to client device 110, either directly or over one or more computer networks, such as a LAN, WAN, or the Internet. Coordinator node 120 is also communicatively coupled to shards 132-134, either directly (e.g., in the same cloud infrastructure) or over one or more computer networks. Coordinator node 120 receives client requests (e.g., vector queries) from client device 110 and determines how to process those client requests, such as generating a different request for each shard and sending each request to the appropriate shard. Alternatively, coordinator node 120 informs client device 110 about which shard(s) contain(s) the target data and client device 110, thereafter, interacts directly with one or more of shards 132-134.

Each of shards 132-134 comprises a database server and a database. A database server may execute on a single computing node or on multiple computing nodes that are connected to the corresponding database. Thus, multiple instances of a database server may be distributed across multiple computing nodes.

A database server comprises a vector query processor that accepts vector queries that (1) coordinator node 120 sends, (2) are submitted by one or more client devices, and/or (3) are retrieved from storage and run regularly. A vector query includes a query vector that is comparable to other vectors that are stored in shards 132-134.

The vector query processor generates an execution plan that comprises multiple operators that are eventually executed in a certain order. Each operator accepts input and generates output. Input may come from another operator or a database object, such as a table or an index. An example operator is a scan operator that takes an identity of a database object as input, scans the database object (e.g., reads contents of the database object into memory), and returns the entire read data (or a portion thereof) to another operator or to an entity that invoked the scan operator. Another example is a top-K operator that takes a query vector and an identity of a set of data as input, leverages a vector index to identify a sorted list of vectors in the set of data, and returns a top-K result. The database server transmits the results (from executing the operators in an execution plan of a vector query) to the submitter thereof (e.g., coordinator node 120 or client device 110), to another entity, and/or to persistent storage for later access by a requesting entity.

A database of a shard persistently stores data, including one or more base tables, each containing vector data. For example, a base table comprises multiple columns, one of which stores vector data. Other columns store other data about data items represented in the base table, such as a row identifier, a data item identifier, and one or more other attributes of the data items. Each row in the base table corresponds to a data item, such as text data, audio data, video data, or image data. For example, a data item may be a portion of a document and the vector data for the data item may be a vector embedding that was generated by an embedding generator based on portion of the document as input thereto. The database may also store all or a portion of a vector index, such as an IVF index or an HNSW index.

### Querying a Sharded Database

There are two main approaches for querying a sharded database. In a first approach, a client (e.g., client device 110) identifies which shard(s) (or database system(s)) that contain the relevant data and sends the query to that shard(s). The client may identify a single shard or multiple shards. Such identification may be based solely on data that the client has access to locally, without consulting a remote computing system. Thus, the client may read partition metadata that indicates how a set of data is partitioned or divided among multiple shards, compare that partition metadata with target data in the query, and determine which shard(s) contain the targeted data. Alternatively, the client sends the query to a query coordinator (e.g., executing on coordinator node 120), which analyzes the vector query and the partition metadata to identify which shards contain the target data. In this alternative, the query coordinator informs the client of the identity of the identified shards so that the client may transmit the query to just those shards. Whichever of the two alternatives is implemented, each shard that receives the query processes the query, generates a result of that processing, and returns the result to the client.

In a second approach, a client sends a query to a query coordinator, which analyzes the vector query and the partition metadata to identify which shards contain the target data, similar to an alternative of the first approach. However, in this second approach, the query coordinator interacts with the identified shards, by sending the query to each identified shard and receiving a query result from each shard. The query coordinator then sends a final result to the client that submitted the query. If the query coordinator received query results from multiple shards, then the final result may be a simple union of the query results or may be another type aggregation of the query results, such as identifying a top K from a set of two top-K results or joining the result with another dataset.

### Sharding Support for Vector Databases

With increasing reliance on vectors to represent data items, there is a need to store and manage vectors in a database. Also, the increase in the amount of data that can be vectorized means that vector databases need to have sufficient storage to accommodate that increase. Some database systems are not equipped, storage-wise, to manage billions or trillions of vectors. Therefore, high-end, expensive database systems with this capability are in demand.

To address this problem of reliance on a single-monolithic (and sometimes expensive) database system, sharding allows for the use of traditional database systems.

In an embodiment, tables are sharded on non-vector columns and a vector index (e.g., HNSW index or IVF index) is generated for each shard. If an IVF index is generated, then the IVF index may be global or may be a local partitioned index. For a single sharded table, some shards may store an IVF index for the corresponding data while other shards may store an HNSW index for the corresponding data. In another implementation, if one shared has a particular type of vector index, then all other shards have the same type of vector index. This has the benefit that the same DDL statements may be run in all the shards and each shard has the same structure.

The following is an example data definition language (DDL) statement that creates a sharded table:
CREATE SHARDED TABLE houses (realtor_id NUMBER PRIMARY KEY, address VARCHAR2(20), image VECTOR)
   PARTITION BY CONSISTENT HASH (realtor_id) TABLESPACE SET ts1;
This DDL statement creates a sharded table named “houses” that has three columns (realtor_id, address, and image) and the table is divided based on a hash of the realtor_id.

The following are two example DDL statements that create different types of vector indexes:
CREATE VECTOR INDEX ivf_image ON houses (image) ORGANIZATION NEIGHBOR PARTITIONS WITH TARGET ACCURACY 95 DISTANCE EUCLIDEAN PARAMETERS (type IVF, NEIGHBOR PARTITIONS 1000) PARALLEL 16;
CREATE VECTOR INDEX hnsw_image ON houses (image) ORGANIZATION INMEMORY NEIGHBOR GRAPH WITH TARGET ACCURACY 95;

The first vector index is an IVF index and the second vector index is an HNSW index. Both DDL statements specify an accuracy level of 95, or 95%. The first DDL statement specifies which distance measurement to use while the second DDL statement does not specify a distance measurement, which may signify that the database system will use a default distance measurement.

### Single-Shard Vector Queries

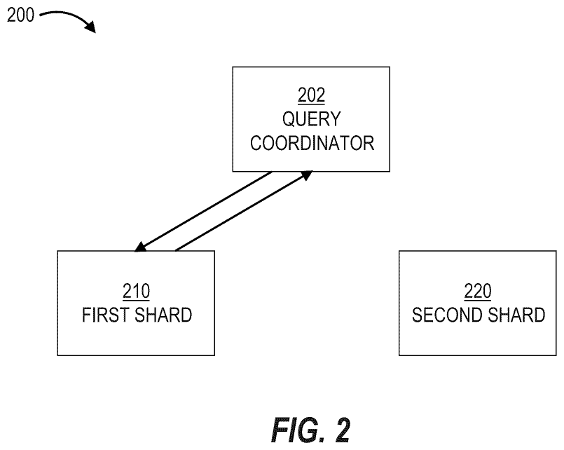

FIG. 2 is a block diagram that depicts a query processing example 200 for a vector query. Element 202 in query processing example 200 corresponds to a query coordinator and indicates operations that the query coordinator performs. Query coordinator 202 executes on a computing node (e.g., coordinator node 120) that is separate from one or more of the shards in a sharded database. In this query processing example, a first shard 210 stores first data from a sharded table and a second shard 220 stores second data from the sharded table. An example of a vector query is the following:
SELECT CUST_ID, NAME
FROM CUSTOMERS
WHERE CUST_ID=10
   ORDER BY VECTOR_DISTANCE (image, ‘[1,0,1]’)
   FETCH APPROX 10 ROWS ONLY;

In this example vector query, there is a single customer table that includes at least a customer ID column, a name column, and an image column that stores vectors that are based on corresponding images. The customer table is sharded based on customer identifier. This example vector query specifies a customer ID, includes a query vector, and requests that ten rows be returned in (descending) order of vector distance.

In this query processing example, query coordinator 202 determines that data about customers with an identifier of ‘10’ resides in first shard 210 and not in second shard 220. Therefore, query coordinator 202 only passes the vector query to first shard 210. (The arrows indicate that communication is occurring between query coordinator 202 and first shard 210, while the lack of arrows between query coordinator 202 and second shard 220 indicate that no communication is occurring between these two entities as a result of query coordinator 202 processing this example vector query.) (In a related embodiment, query coordinator 202 sends the vector query to one or more other shards, not depicted, but not to second shard 220.) First shard 210 processes the vector query, identifies the top K of customers with the closest image to the query vector, and returns the top K result to query coordinator 202, which stores this result or forwards this result to an intended destination, such as the client that originally submitted the vector query to query coordinator 202.

### Multi-Shard Vector Queries

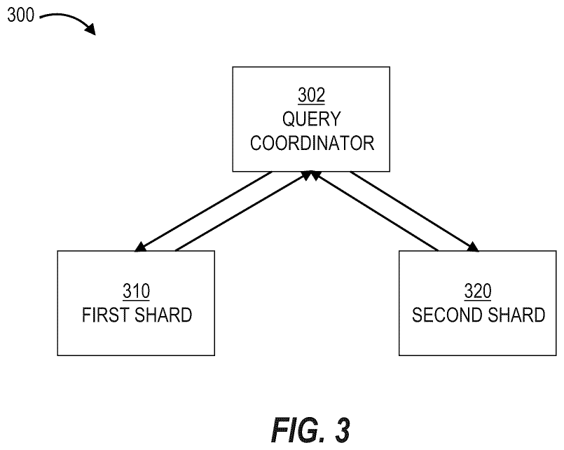

FIG. 3 is a block diagram that depicts a query processing example 300 for a vector query. Element 302 in query processing example 300 corresponds to a query coordinator, similar to query coordinator 202 described above. Again, in this query processing example, a first shard 310 stores first data of a sharded table and a second shard 320 stores second data of the sharded table. An example of a vector query is the following:
SELECT CUST_ID, NAME
FROM CUSTOMERS
   ORDER BY VECTOR_DISTANCE (image, ‘[1,1,1]’)
   FETCH APPROX FIRST 10 ROWS ONLY;
SELECT V.C, V.N FROM SHARD_ITERATOR
   (SELECT CUST_ID C, NAME N
   VECTOR DISTANCE (image, ‘[1,1,1]’) D FROM CUSTOMERS
   ORDER BY VECTOR DISTANCE (image, ‘[1,1,1]’)
   FETCH APPROX FIRST 10 ROWS ONLY) V
ORDER BY V.D FETCH FIRST 10 ROWS ONLY.

In this example vector query, query coordinator 302 converts the first vector query (beginning with the first SELECT) into the second vector query (beginning with the second SELECT) in order to distribute the query processing among the shards. Query coordinator 302 then pushes the inner query of the second vector query down to each shard (as indicated by the arrows between query coordinator 302 and each of shards 310 and 320.) After each shard generates a top-K result and returns that result to query coordinator 302, query coordinator 302 processes the second part of the second vector query, which effectively combines the two top-K results from the two shards and produces a final top-K result. In other words, the inner query that creates the view V is executed on all the shards (310, 320 in this example). The outer query that selects from the view V is then run on query coordinator 302 to combine the top-K results.

This example vector query involves querying a single table. However, this general query processing example applies in the scenario where the vector query involves querying multiple tables and a join operation is performed. In an embodiment, if query coordinator 302, upon receiving the vector query, determines that the join operation is a collocated join, then the query processing of FIG. 3 is followed. However, if query coordinator 302 determines that the join operation is a non-collocated join, then one of the following non-collocated join examples may be followed. A non-collocated join must be performed by query coordinator 302 and cannot be pushed down to individual shards because doing so would likely prevent many corresponding rows to be joined from the two sharded tables, resulting in very few results, which would not be accurate. Accuracy is sacrificed (if at all) if an approximate vector index is utilized.

### Cross-Shard Vector Queries (Non-Collocated Joins)

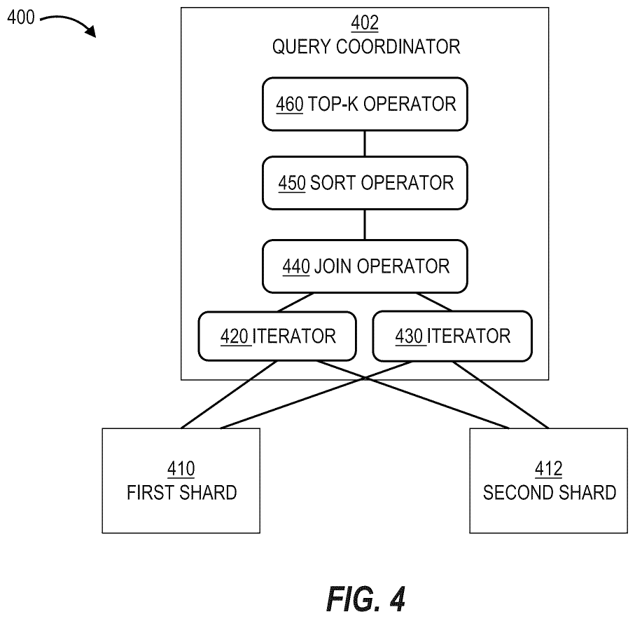

FIG. 4 is a block diagram that depicts a query processing example 400 for naively processing a vector query that involves a non-collocated join. Element 402 in query processing example 400 corresponds to a query coordinator, similar to query coordinators 202 and 302 described above. Again, in this query processing example, query coordinator 402 interacts with shards 410-412 that collectively store a customers table and a drivers table. Again, other implementations may have more shards for each sharded table.

An example of a vector query is the following:
SELECT C.CUST_ID, C.NAME
FROM CUSTOMERS C DRIVERS D
WHERE C.ZIP=D.ZIP//this is a join on a non-sharding key
   ORDER BY VECTOR_DISTANCE (image, ‘[1,1,1]’)
   FETCH APPROX FIRST 10 ROWS ONLY;
Query coordinator 402 converts this vector query into the following modified vector query:
SELECT V1.C, V1.N
FROM
   SHARD_ITERATOR (SELECT CUST_ID C, NAME N, ZIP Z,
      VECTOR_DISTANCE (image, ‘[1,1,1]’) D FROM CUSTOMERS) V1
   SHARD_ITERATOR (SELECT ZIP Z FROM DRIVERS) V2
WHERE V2.Z=V1.Z
ORDER BY V.D
FETCH APPROX FIRST 10 ROWS ONLY.

Thus, query coordinator 402 determines, based on the original vector query, that the vector query includes a non-collocated join. This mean that, even though a particular shard may contain some customer data and some driver data, a data item from the customer data in the particular shard might join with a data item from the driver data in a different shard. (Each data item corresponds to a row or a portion of a row, and, thus, contains one or more column values.) Therefore, joining the customer data and driver data in a single shard might not result in an accurate result since at least one join of two data items would not happen.

In response to this non-collocated join determination, query coordinator 402 includes two shard iterators: one iterator 420 for retrieving customer data from shards 410-412 and another iterator 430 for retrieving driver data from shards 410-412. Query coordinator 402 also includes a join operator 440 that joins the results from both iterators, a sort operator 450, and a Top-K operator 460. Query coordinator 402 pushes down the first subquery and the second subquery in the modified vector query to shards 410-412, each subquery targeting a different sharded table. Part of the first subquery is calculating a vector distance for each data item in the customers table. The other part of the first subquery is returning the customer ID, name, and zip code of each customer indicated in the customers table. The second subquery returns just the zip code of each driver indicated in the drivers table. This allows join operator 440 to perform a join operation on the respective zip code columns.

After the join operation, sort operator 450 accepts, as input, the distance values of the data items that resulted from the join operation and sorts the data items based on their respective distance values. Thereafter, Top-K operator 460 selects the top K of the sorted data items. Query coordinator 402 processes the top K, which may involve storing the top K in persistent storage or transmitting the top K (and, optionally, their respective distance values) to an intended recipient, such as a client device that submitted the original vector query.

### Csq—Non-Collocated Join—Pre-Filtering

The above example of a cross-shard vector query (CSQ) with a non-collocated join illustrates an implementation where every row from each sharded table is returned to query coordinator 402. Also, a vector distance calculation is performed for each row on a vector column of a sharded table (the customers table in this example). Vector distance calculations are computationally intensive, requiring significant processor (CPU) time, memory, and power. Furthermore, in the context of sharded databases, transferring vector distances between multiple shards and a query coordinator utilizes significant network bandwidth, slowing down other network traffic. It is preferrable that the number of vector distance calculations is reduced as much as possible.

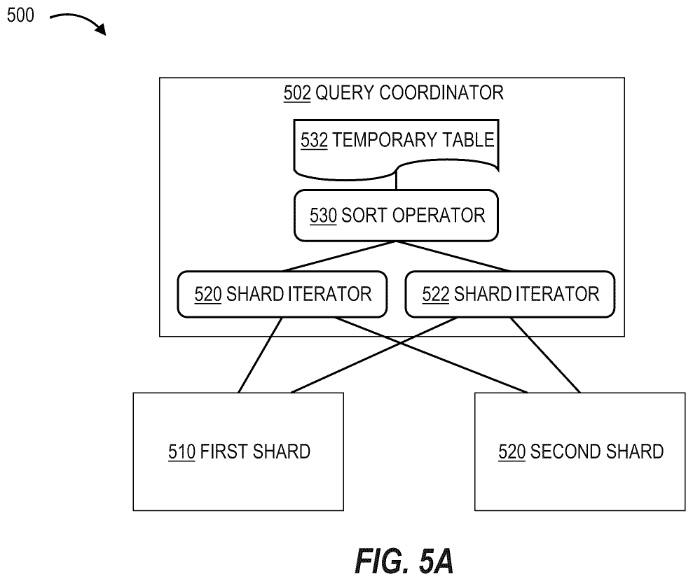

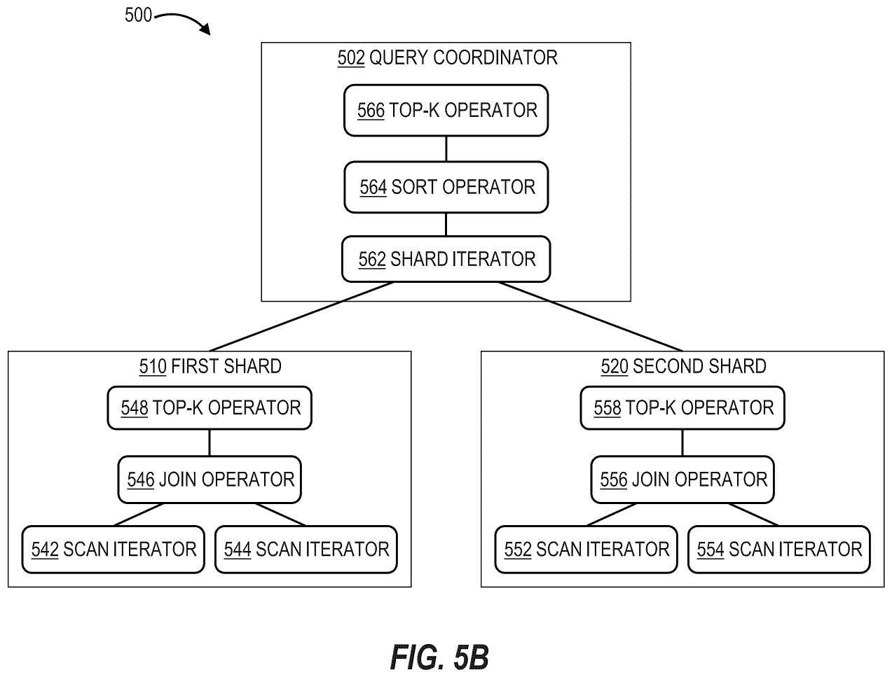

FIGS. 5A-5B are block diagrams that depict a query processing example 500 for processing a vector query that involves a non-collocated join and an added pre-filter operation, in an embodiment. Query processing example 500 involves two main steps or stages: a join stage (depicted in FIG. 5A) followed by a join back stage (depicted in FIG. 5B). This example is illustrated using the same original vector query as in query processing example 400.

A query coordinator 502 receives a vector query, determines that the vector query involves a non-collocated join (on the zip columns of the two sharded tables: the customers table and the drivers table), and establishes multiple operators for the join stage, including two shard iterators 520-522 and a join operator 530. When join operator 530 is performed, query coordinator 502 stores results of join operator 530 into a temporary table 532.

Shard iterators 520-522 send data requests for specific columns of specific sharded tables (i.e., customers table and drivers table in this example), which tables are spread among multiple shards, which are shards 510-512 in this example. The respective shards perform the requested scan operations (e.g., reading just the respective zip column of the two sharded tables and the respective row ID columns of the two sharded tables) and return their respective results to query coordinator 502.

Shard iterator 520 receives the requested customer data from shards 510-512 and shard iterator 522 receives the requested driver data (also) from shards 510-512. (In other words, each shard 510-512 stores both customer data and driver data.) Then, join operator 530 joins the two sets of data based on the values in the zip columns. If two values in two zip columns match, then the corresponding row IDs are identified and stored in temporary table 532.

For example, a single customer indicated in the customers table may have a zip code value that matches a zip code value of multiple drivers indicated in the drivers table. Similarly, a single driver indicated in the drivers table may have a zip code value that matches a zip code value of multiple customers indicated in the customers table. Also, one or more customers indicated in the customers table may have a zip code value that does not match any zip code value in the drivers table. Similarly, one or more drivers indicated in the drivers table may have a zip code value that does not match any zip code value in the customers table.

After join operation 530 completes and temporary table 532 ceases to increase in data, the second main stage of query processing 500 may proceed: the join back stage. In this join back stage, each shard performs four operations: a scan operator (542 on shard 510, 552 on shard 512) on the customers table, a scan operator (544 on shard 510, 554 on shard 512) on temporary table 532, a join operator (546 on shard 510, 556 on shard 512) on the outputs of the respective scan operators (i.e., 542-544 on shard 510 and 552-554 on shard 512), and a Top-K operator (548 on shard 510, 558 on shard 512).

Scanning temporary table 532 may involve a shard (e.g., shard 510) sending, to query coordinator 502, a request for contents of the temporary table 532. The request may be for all contents or a subset thereof. For example, the request may be for the first one thousand rows or entries from temporary table 532, which request is followed by a subsequent request for the next thousand rows (or entries). These requests to query coordinator 502 may repeat until query coordinator 502 provides, to the shard, a response that indicates that there are no more rows. For example, if a response is less than one thousand rows, then the shard determines that there are no more rows in temporary table 532 and, therefore, will not send subsequent requests for data from temporary table 532.

The join operator (546, 556) in each shard (510, 512) joins the row IDs of its portion of the customers table with the row IDs of temporary table 532. After this join operator performs its operation, the top-K operator proceeds.

Identifying the top-K from the output of the join operator may involve searching a vector index, such as an HNSW index or an IVF index, each of which is described in more detail in U.S. patent application Ser. No. 18/885,640, which is incorporated by reference as if fully described herein. Each shard may store a vector index that indexes vectors in that shard's portion of a sharded table. Searching a vector index does not guarantee 100% accuracy, unless all clusters in an IVF index are searched (in cases where the vector index is an IVF index) or there is no limit to the number of neighbors considered while traversing a neighbor graph of the HNSW index (in cases where the vector index is an HNSW index). However, if the number of results from a join operator (e.g., join operator 546) is relatively few, then a vector distance calculation may be performed between the query vector and the vector associated with each result, i.e., without searching the vector index. Also, in cases where the number of results from the join operator is relatively high, then searching a vector index might not yield enough results (in a vector index search) that match the results for a join operator (e.g., join operator 546). For a single vector query, some shards might utilize a vector index to identify the top K at this stage, while other shards might not utilize a vector index.

Each shard (510, 512) sends its respective top K results to query coordinator 502. Query coordinator 502 includes three operators: shard iterator 562, sort operator 564, and a Top-K operator 566. Shard iterator 562 receives the top K results from each of Top-K operator 548 and 558. Shard iterator 562 combines both top K results, such as concatenating one top-K result to the other top-K result. Sort operator 564 sorts the combined top K results (e.g., in descending order) and Top-K operator 566 identifies the top K of the sorted results.

### Pre-Filtering Process Over View

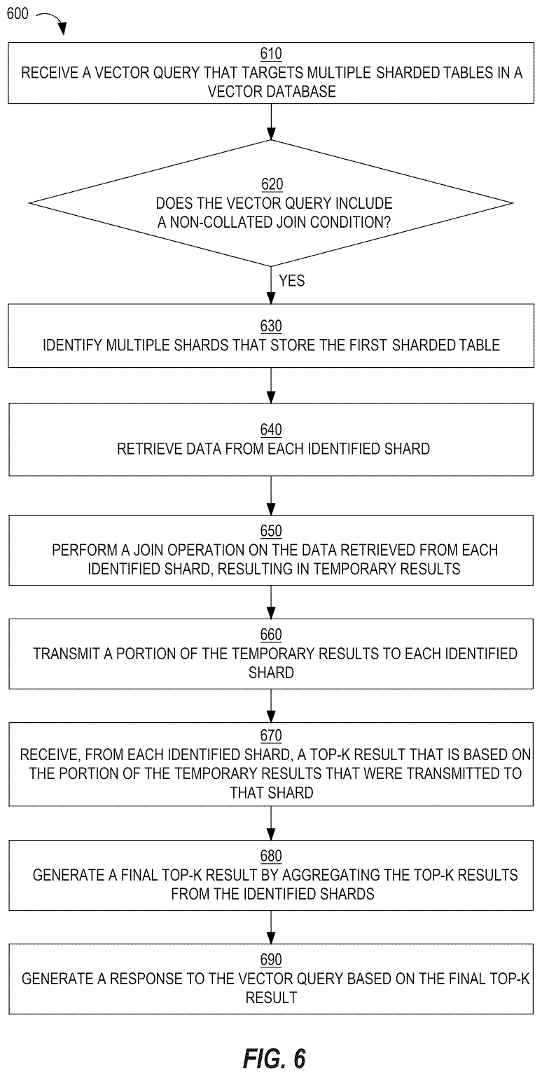

FIG. 6 is a flow diagram that depicts an example process 600 for processing a CSQ with a non-collocated join, in an embodiment. Process 600 may be performed by a query coordinator, such as query coordinator 502.

At block 610, a vector query that targets multiple sharded tables in a vector database is received. The vector query may be received from a client device (e.g., a laptop computer, a smartphone) over a computer network, such as the Internet or a local area network (LAN).

At block 620, in response to receiving the vector query, it is determined whether the vector query includes a non-collocated join condition on those sharded tables. If so, then process 600 proceeds to block 630; otherwise, process 600 ends.

At block 630, multiple shards that store the sharded tables are identified. Block 630 and subsequent blocks are performed in response to determining that the vector query includes a non-collocated join condition. Block 630 may involve looking up a mapping in memory that indicates where each sharded table is stored. For example, one sharded table may be stored on a set of shards and another sharded table may be stored on the same set of shards or on a different (possible overlapping) set of shards.

At block 640, data is retrieved from each identified shard. Block 640 may involve retrieving, from a set of shards, first data pertaining to the first sharded table and second data pertaining to the second sharded table. Block 640 may be preceded by transmitting, to each identified shard, a request for that shard's portions of the sharded tables.

At block 650, a join operation is performed on the data retrieved from the multiple shards. Thus, data from one sharded table is joined with data from another sharded table. Performing the join operation generates temporary results.

At block 660, a portion of the temporary results is transmitted to each identified shard. Block 660 may be performed in response to receiving a request for the portion from a shard.

At block 670, for each shard of the identified shards, a top-K result, that is based on the portion of the temporary results that were transmitted to that shard, is received from that shard. Thus, block 670 comprises receiving multiple top-K results, one from each shard. Although not performed by query coordinator 502, each shard generates its top-K result based on multiple scan operations, a join operation, and, optionally, a search of a vector index.

At block 680, the top K results from the identified shards are aggregated to generate a final top-K result. It is possible that no result from the top-K result from one shard appears in the final top-K result.

At block 690, a response to the vector query is generated based on the final top-K result. The response may be limited to data from one or more columns of one of the sharded tables (e.g., Name and Customer ID), depending on the semantics of the vector query. Also, the response may order items in the data (e.g., corresponding to different customers) based on the computed vector distances. In fact, the response may include the computed vector distances. Block 690 may involve transmitting the response to the submitter of the vector query and/or storing the response.

### CSQ—Non-Collocated Join—Post-Filtering

In a different embodiment, a CSQ with a non-collocated join includes post-filtering with a join back stage, where the main or final join is performed after a vector index is accessed.

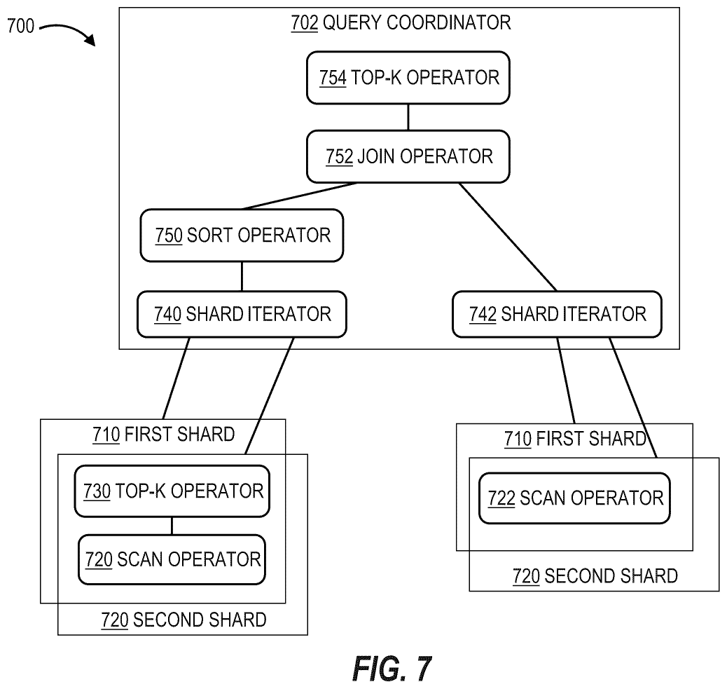

FIG. 7 is a block diagram that depicts a query processing example 700 for processing a vector query that involves a non-collocated join with post-filtering, in an embodiment. Query processing example 700 involves a single join stage, which comes after a vector index is accessed. This example is illustrated using the same original vector query as in query processing example 400.

Generally, post-filtering has better performance than pre-filtering. A disadvantage of post-filtering is that there might not be enough rows after the join, meaning less than K results. However, in an embodiment, a query coordinator selects post-filtering over pre-filtering based on statistics on the join column. For example, if it is determined, based on statistics on the join column, that the join predicate is not very selective (meaning few rows will pass the join predicate and, hence, be selected), then the pre-filtering approach may be selected. Conversely, if it is determined that the join predicate is highly selective (meaning many rows will pass the join predicate), the post-filtering approach may be selected. If a post-filtering approach is implemented, then multiple rounds of communication between the query coordinator and the shards may be used in order to achieve K rows in the final result. In other words, each round of communication results in <K rows until a total of K rows are identified, which causes the rounds of communication to cease.

A query coordinator 702 receives a vector query, determines that the vector query involves a non-collocated join (e.g., on the zip columns of two sharded tables on shards 710-712: the customers table and the drivers table), and causes multiple scan operators 720-722 and a Top-N operator 730 to be pushed to each shard 710, 712. The value of “N” in “Top-N” is greater than the value of “K” in “Top-K.” Scan operator 720 scans the customers table and scan operator 722 scans the drivers table. Each shard 710, 712 sends the scanned drivers data to query coordinator 702. Each shard 710, 712 also executes Top-N operator 730, which identifies the top N data items from scan operator 720. Top-N operator 730 may perform a search of a vector index (built upon the customers table) given a query vector in the vector query, in order to identify a set of customers that are associated with a vector that is (approximately) in the top N of all vectors in the customers table. Top-N operator 730 outputs N data items, each of which is found in the top N. Each shard 710, 712 sends its top N results to query coordinator 702. Such sending may be in response to a request from query coordinator 702.

Query coordinator 702 also generates, for executing the vector query, two shard iterators 740-742 (that receive data from shards 710-712, a sort operator 750 that sorts the output of shard iterator 740, a join operator 752 that joins the results from sort operator 750 and from shard iterator 742, and a Top-K operator 754 that identifies the top-K from the output of join operator 752.

Shard iterator 740 receives a top N result from each of multiple shards (e.g., 710-712). Sort operator 750 sorts the multiple top N results that shard iterator 740 receives. Shard iterator 742 also receives scanned data from each of multiple shards, except this received scanned data is not based on a top N search that is performed on one or more of the shards. In this example, the scanned data is data from the drivers table. Sort operator 750 may reduce the total of the top N results to be N. For example, if there are only two shards and each transmits fifty rows to query coordinator 702, then sort operator 750 outputs fifty rows from the total of one hundred rows. Alternatively, sort operator 750 does not reduce the total of the top N results; instead, sort operator 750 outputs all the top N results (but in sorted order).

Join operator 752 joins (1) the sorted top N results from sort operator 750 with (2) the data from shard iterator 742. In this example, the join condition is that the zip code value of the sorted top N results matches the zip code value of the data from shard iterator 742. Because searching the HNSW index and performing a top-N determination both occur prior this join operation, the join operation is (presumably) taking into account many fewer rows or data items, depending on the size of N. The latency of some techniques for searching vector indexes is acceptable; therefore, any subsequent join based on output from such searches is acceptable.

Top-K operator 754 receives the output from join operator 752 and generates a top-K result from that output. Such generation may involve first sorting the output from join operator 752 (i.e., based on vector distance to the query vector) and then identifying the top K results. If the number of results (e.g., rows) in the output from join operator 752 is less than K, then there are multiple options. In one option, the entire process may be performed again, but where the value is N is increased. Such increase may be based on a difference between K and the number of results from join operator 752. For example, N may be increased by multiplying N by the quotient of K and that difference. In another option, in the case where sort operator 750 reduces the total number of top N results to N, the removed results are considered for joining (by join operator 752) with the data from shard iterator 742. In this option, if there is a sufficient number of rows to arrive at a top-K result, then communication with shards 710-712 (to retrieve more data from the customers table) is avoided.

### Post-Filtering Process Over View

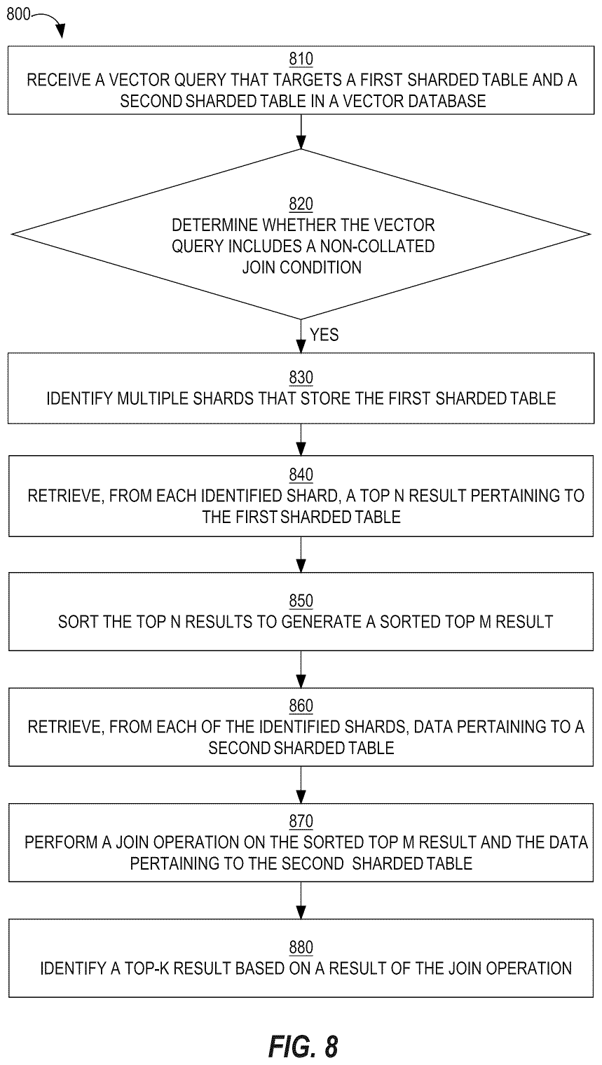

FIG. 8 is a flow diagram that depicts an example process 800 for processing a CSQ with a non-collocated join, in an embodiment. Process 800 may be performed by a query coordinator, such as query coordinator 702.

At block 810, a vector query that targets a first sharded table and a second sharded table in a vector database is received. The vector query may have been specified by a user operating a computing device that is communicatively coupled (via a computer network) to a database system, upon which the query coordinator executes. The vector query includes a query vector.

At block 820, in response to receiving the vector query, it is determined whether the vector query includes a non-collocated join condition on the first sharded table and the second sharded table. If so, process 800 proceeds to block 830; otherwise, process 800 ends. Block 820 may comprise additional checks, such as determining whether the vector query is a well-formed query, whether the target data is known and accessible to the database system, etc.

At block 830, multiple shards storing the first sharded table are identified. In other words, each identified shard stores a different part or portion of the first sharded table. The query coordinator may have access to metadata that maps the identity of each sharded table to storage locations for each shard of each sharded table. Each storage location of a sharded table is a different database or database system. For example, two tables are CUSTOMERS and DRIVERS and different partitions for the CUSTOMERS table are stored, respectively, on shards S1, S2, and S3. Similarly, different partitions for the DRIVERS table are stored, respectively, on shards S1, S2, and S3. Block 830 and subsequent blocks are performed in response to determining that the vector query includes a non-collocated join condition.

At block 840, a top N result pertaining to the first sharded table is retrieved from each identified shard. Block 840 may be preceded by transmitting, to each shard that stores a portion of the first sharded table, the query vector and a request for the top N results, which are the items with the closest N indexed vectors to the query vector. Each shard, in response to the request, leverages a vector index to identify the top N closest indexed vectors.

At block 850, the top N results from the identified shards are sorted to generate a sorted top M result. The value of M may be N or a different value than N.

At block 860, data pertaining to a second sharded table that is different than the first sharded table is retrieved from each of the identified shards. Block 860 may have been preceded by the query coordinator transmitting, to each shard that stores the second sharded table, a request for the sharded table.

At block 870, a join operation is performed on the sorted top M result and the data pertaining to the second sharded table. The join operation is performed using common columns in the sorted top M result and the data from the second sharded table.

At block 880, a top-K result is identified based on a result of the join operation. Block 880 may involve sorting the results of the join operation and then selecting the top K of the sorted results. If the number of items in the result of the join operation is less than K, then additional results are identified. The additional results may be identified using one of multiple techniques.

In a first technique, an additional set of results from the top N results from the plurality of shards is identified. For example, if K is 10, N is 30, and the number of shards is 3, then the total of the top N results is 30×3=90. If M is 30, then the next 30 items from that 90 may be identified and joined with the data pertaining to the second sharded table. If the number of items in this later join and the number of items from the join in block 870 is at least as great as K, then the top K from the combination of both joins is identified. Otherwise, additional items from the combination of top N results may be retrieved and joined with the data pertaining to the second sharded table.

In a second technique, the value of N is increased to P, which is greater than N. For example, if N is 30, then P may be 60. Then, the query coordinator transmits a request to each identified shard for the top P result pertaining to the first sharded table. Each shard may leverage the same vector index as before. The query coordinator retrieves, from each identified shard, a top P result. The query coordinator then sorts the top P results from the plurality of shards to generate a sorted top Q result. Then, the query coordinator performs a second join operation on the sorted top Q result and the data pertaining to the second sharded table. From the results of the second join operation.

Additionally, block 880 may involve storing the top-K result in persistent storage and/or transmitting the top-K result to the entity that submitted the vector query.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

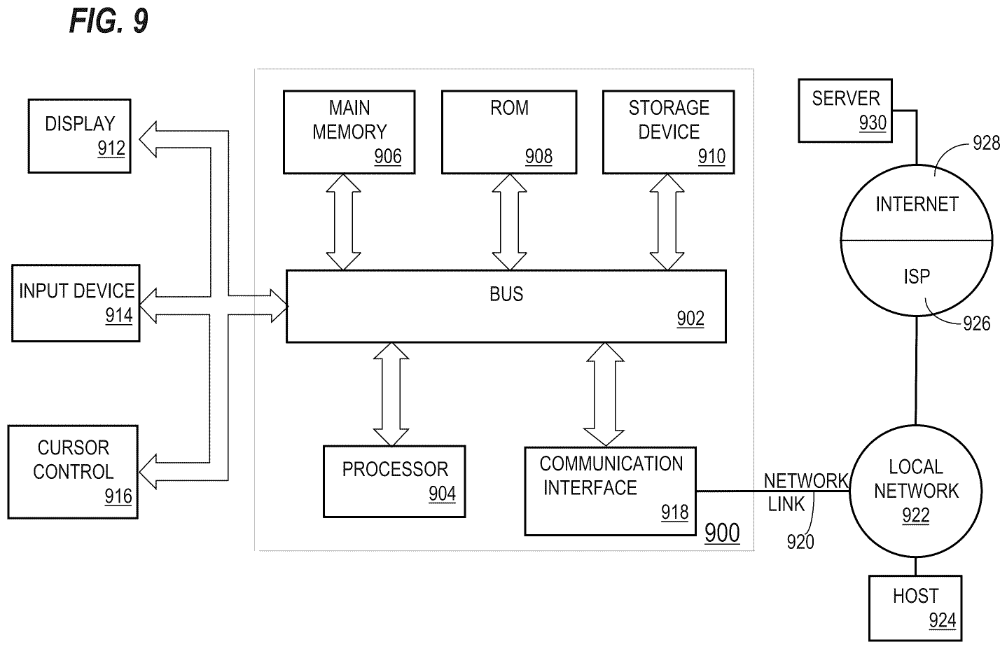

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the worldwide packet data communication network now commonly referred to as the “Internet” 928. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Software Overview

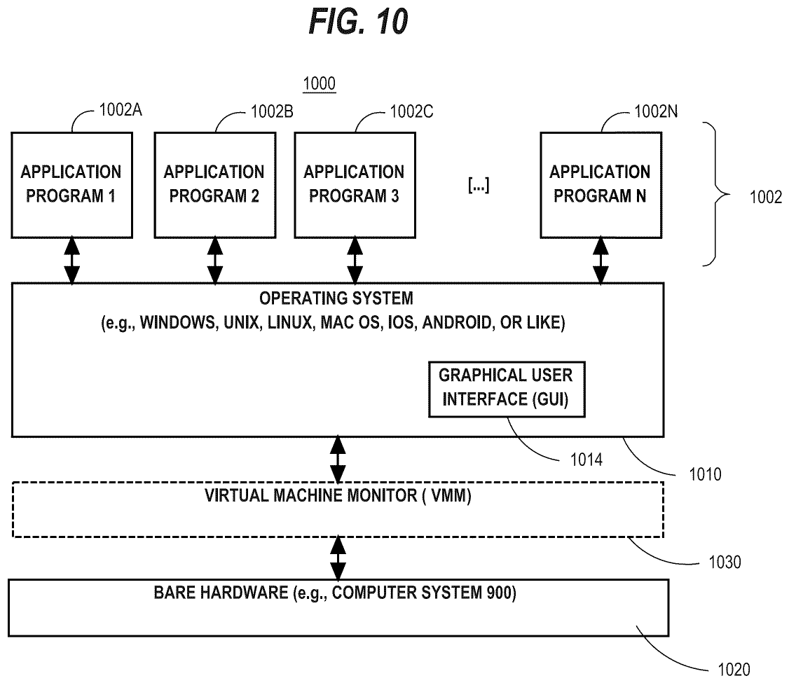

FIG. 10 is a block diagram of a basic software system 1000 that may be employed for controlling the operation of computer system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computer system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by the system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 900 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a vector query that targets a first sharded table and a second sharded table in a vector database;
in response to receiving the vector query, determining whether the vector query includes a non-collocated join condition on the first sharded table and the second sharded table;
in response to determining that the vector query includes the non-collocated join condition:
identifying a plurality of shards storing the first and second sharded tables;
retrieving, from the plurality of shards, first data pertaining to the first sharded table and second data pertaining to the second sharded table;
performing a join operation on the first data and the second data, wherein performing the join operation generates temporary results;
transmitting, to each shard of the plurality of shards, a portion of the temporary results;
for each shard of the plurality of shards, receiving, from said each shard, a top K result that is based on the portion of the temporary results that were transmitted to said each shard;
generating a final top K result based on the top K results from the plurality of shards;
generating a response to the vector query based on the final top K result;
wherein the method is performed by one or more computing devices.

2. The method of claim 1, wherein the method further comprising, prior to receiving the top K result:
for each shard of the plurality of shards, performing, by said each shard, a second join operation that joins (i) third data from the first sharded table with (ii) fourth data from the portion of the temporary results;
wherein the top K result is based on results from the second join operation.

3. The method of claim 2, wherein the vector query includes a query vector, the method further comprising:
for each shard of the plurality of shards:
for each result of the results from the second join operation:
generating a vector distance between the query vector and a vector associated said each result;
adding the vector distance to a set of vector distances;
identifying, by said each shard, the top K vector distances from the set of vector distances;
transmitting, by said each shard, the top K vector distances to a query coordinator.

4. The method of claim 1, further comprising, prior to transmitting the portion:
receiving, from each shard of the plurality of shards, a request for at least the portion of the temporary results.

5. The method of claim 1, wherein generating the final top K result comprises:
aggregating the top K results from the plurality of shards to generate an aggregated result;
sorting the aggregated result to generate a sorted aggregated result;
identifying the final top K from the sorted aggregated result.

6. A method comprising:
receiving a vector query that targets a first sharded table and a second sharded table in a vector database;
in response to receiving the vector query, determining whether the vector query includes a non-collocated join condition on the first sharded table and the second sharded table;
in response to determining that the vector query includes the non-collocated join condition:
identifying a plurality of shards of the first sharded table;
retrieving, from each of the plurality of shards, a top N result pertaining to the first sharded table;
sorting the top N results from the plurality of shards to generate a sorted top M result;
retrieving, from each of the plurality of shards, data pertaining to the second sharded table;
performing a join operation on the sorted top M result and the data pertaining to the second sharded table;
identifying a top K result of the vector query after performing the join operation;
wherein the method is performed by one or more computing devices.

7. The method of claim 6, further comprising:
determining whether the number of items in the result of the join operation is greater than or equal to K;
in response to determining that the number of items is not greater than or equal to K:
identifying an additional set of results from the top N results from the plurality of shards;
performing a second join operation on the additional set of results and the data pertaining to the second sharded table;
wherein identifying the top K result is also based on results of the second join operation.

8. The method of claim 6, further comprising:
determining whether the number of items in the result of the join operation is greater than or equal to K;
in response to determining that the number of items is not greater than or equal to K:
increasing N to P;
retrieving, from each of the plurality of shards, a top P result pertaining to the first sharded table;
sorting the top P results from the plurality of shards to generate a sorted top Q result;
identifying the data pertaining to the second sharded table;
performing a second join operation on the sorted top Q result and the data pertaining to the second sharded table;
wherein identifying a top K result is based on results of the second join operation.

9. The method of claim 6, wherein the vector query includes a query vector, the method further comprising:
for each shard of the plurality of shards:
performing a search, by said each shard, of a vector index based on the query vector and data from the first sharded table;
wherein performing the search results in identifying the top N result;
sending, by said each shard, the top N result to a query coordinator.

10. One or more non-transitory storage media storing instructions which, when executed by one or more computing devices, cause:
receiving a vector query that targets a first sharded table and a second sharded table in a vector database;
in response to receiving the vector query, determining whether the vector query includes a non-collocated join condition on the first sharded table and the second sharded table;
in response to determining that the vector query includes the non-collocated join condition:
identifying a plurality of shards storing the first and second sharded tables;
retrieving, from the plurality of shards, first data pertaining to the first sharded table and second data pertaining to the second sharded table;
performing a join operation on the first data and the second data, wherein performing the join operation generates temporary results;
transmitting, to each shard of the plurality of shards, a portion of the temporary results;
for each shard of the plurality of shards, receiving, from said each shard, a top K result that is based on the portion of the temporary results that were transmitted to said each shard;
generating a final top K result based on the top K results from the plurality of shards;
generating a response to the vector query based on the final top K result.

11. The one or more storage media of claim 10, wherein the method further comprising, prior to receiving the top K result:
for each shard of the plurality of shards, performing, by said each shard, a second join operation that joins (i) third data from the first sharded table with (ii) fourth data from the portion of the temporary results;
wherein the top K result is based on results from the second join operation.

12. The one or more storage media of claim 11, wherein the vector query includes a query vector, the method further comprising:
for each shard of the plurality of shards:
for each result of the results from the second join operation:
generating a vector distance between the query vector and a vector associated said each result;
adding the vector distance to a set of vector distances;
identifying, by said each shard, the top K vector distances from the set of vector distances;
transmitting, by said each shard, the top K vector distances to a query coordinator.

13. The one or more storage media of claim 10, further comprising, prior to transmitting the portion:
receiving, from each shard of the plurality of shards, a request for at least the portion of the temporary results.

14. The one or more storage media of claim 10, wherein generating the final top K result comprises:
aggregating the top K results from the plurality of shards to generate an aggregated result;
sorting the aggregated result to generate a sorted aggregated result;
identifying the final top K from the sorted aggregated result.

15. One or more storage media storing instructions which, when executed by one or more computing devices, cause:
receiving a vector query that targets a first sharded table and a second sharded table in a vector database;
in response to receiving the vector query, determining whether the vector query includes a non-collocated join condition on the first sharded table and the second sharded table;
in response to determining that the vector query includes the non-collocated join condition:
identifying a plurality of shards of the first sharded table;
retrieving, from each of the plurality of shards, a top N result pertaining to the first sharded table;
sorting the top N results from the plurality of shards to generate a sorted top M result;
retrieving, from each of the plurality of shards, data pertaining to the second sharded table;
performing a join operation on the sorted top M result and the data pertaining to the second sharded table;
identifying a top K result of the vector query after performing the join operation.

16. The one or more storage media of claim 15, wherein the instructions, when executed by the one or more computing devices, further cause:
determining whether the number of items in the result of the join operation is greater than or equal to K;
in response to determining that the number of items is not greater than or equal to K:
identifying an additional set of results from the top N results from the plurality of shards;
performing a second join operation on the additional set of results and the data pertaining to the second sharded table;
wherein identifying the top K result is also based on results of the second join operation.

17. The one or more storage media of claim 15, wherein the instructions, when executed by the one or more computing devices, further cause:
determining whether the number of items in the result of the join operation is greater than or equal to K;
in response to determining that the number of items is not greater than or equal to K:
increasing N to P;
retrieving, from each of the plurality of shards, a top P result pertaining to the first sharded table;
sorting the top P results from the plurality of shards to generate a sorted top Q result;
identifying the data pertaining to the second sharded table;
performing a second join operation on the sorted top Q result and the data pertaining to the second sharded table;
wherein identifying a top K result is based on results of the second join operation.

18. The one or more storage media of claim 15, wherein the vector query includes a query vector, wherein the instructions, when executed by the one or more computing devices, further cause:
for each shard of the plurality of shards:
performing a search, by said each shard, of a vector index based on the query vector and data from the first sharded table;
wherein performing the search results in identifying the top N result;
sending, by said each shard, the top N result to a query coordinator.
